(19) United States
(12) Patent Application Publication
(10) Pub. No.: US 2005/0193785 A1
(43) Pub. Date: Sep. 8, 2005

(54) AUTOMOBILE STEERING WHEEL LOCK

(76) Inventor: Yu-Pin Lin, Tainan Hsien (TW)

Correspondence Address: Yu-Pin Lin, P.O. Box 90, Tainan City, 704, TW

(21) Appl. No.: 10/667,397

(22) Filed: Sep. 23, 2003

(51) Int. Cl. B60R 25/02

(52) U.S. Cl. 70/209

(57) ABSTRACT

An automobile steering wheel lock comprises a key body, a lockset, two hooked rods, a central rod, an upper shell and a lower shell. The lockset has a base, a spring coil, a stop block, a lock core and a rotatable plate. To lock a steering wheel, the hooked rods are engaged with the inner rim of a steering wheel. The central rod is pulled outwardly from the lock body till its hook is engaged with the opposite inner rim of the wheel, and therefore the wheel cannot be rotated and the airbag of which is protected. To unlock the wheel, a key is used to rotate the lock core, and the rotatable plate rotates accordingly so as to turn a tooth of a stop block and decouple the stop block with the central rod, allowing the central rod to move back to the lock body.

### BACKGROUND OF THE INVENTION

1. Field of the Invention

The present invention relates to automobile steering wheel locks, and more particularly an automobile steering wheel lock comprising a key body, a lockset, two hooked rods, a central rod, an upper shell and a lower shell. The lockset has a base, a spring coil, a stop block, a lock core and a rotatable plate. To lock a steering wheel, the hooked rods are engaged with the inner rim of a steering wheel. The central rod is pulled outwardly from the lock body till its hook is engaged with the opposite inner rim of the wheel, and therefore the wheel cannot be rotated and the airbag of which is protected. To unlock the wheel, a key is used to rotate the lock core, and the rotatable plate rotates accordingly so as to turn a tooth of a stop block and decouple the stop block with the central rod, allowing the central rod to move back to the lock body. An automobile steering wheel lock according to the present invention is thus easily operable.

2. Description of the Prior Art

An automobile steering wheel lock of the prior art mainly comprises a main body 10 and a retractable rod 11, respectively having hook members 100, 110 that are oppositely facing. The main body 10 is provided with a lock body 101, which has a lock core 102. The main body 10 is further provided with a channel 103 passing therethrough for receiving the retractable rod 11. The retractable rod 11 has a plurality of annular grooves 111 formed on one end section opposite to the end having a hook member. By pulling the retractable rod 11 away from the main body 10, the hook members 100, 110 are engaged with the inner rim of a steering wheel, so that the wheel cannot be rotated.

However, the automobile steering wheel lock of the prior art is disadvantageous in that the retracted body is still too long for storage and transportation.

### SUMMARY OF THE INVENTION

Accordingly, the primary object of the present invention is to provide an automobile steering wheel lock that is easily operable and can be folded into a compact configuration for storage, with even better anti-theft effect.

To achieve above objects, the present invention provides an automobile steering wheel lock that is comprising characterized by a lock body a through channel and a chamber and a recess room connectedly formed, which chamber connects with the channel on a lateral side thereof. Two opposite lateral sides of the lock body are each provided with an indentation and a locating notch. The automobile steering wheel lock is further characterized by a lockset housed within the chamber and the recess room. The automobile steering wheel lock further comprises two hooked rods mounted within the locating notches of the lock body. Each of the hooked rods is provided with a hook member at a first end thereof and a pivot stand at a second end thereof. Each of the pivot stands is pivotally mounted onto a bottom inner wall of a corresponding indentation. The automobile steering wheel lock further comprises a central rod housed within the lock body through the channel therein. A rod body of the central rod is provided with a plurality of annular grooves that distribute along a first end section thereof, and a hook member is fixedly mounted a second end section of the rod body.

The various objects and advantages of the present invention will be more readily understood from the following detailed description when read in conjunction with the appended drawings.

### BRIEF DESCRIPTION OF DRAWINGS

FIG. 1 is a perspective view of an automobile steering wheel lock of the prior art;

FIG. 2 is an exploded perspective view of the lock body of an automobile steering wheel lock according to the present invention;

FIG. 3 is an exploded perspective view of the hooked rods and the central rod of an automobile steering wheel lock according to the present invention;

FIG. 4 is a perspective view of the present invention;

FIG. 5 is a cross-sectional view of the lock body of the present invention in the locked configuration;

FIG. 6 is a cross-sectional view of the lock body of the present invention in the unlocked configuration;

FIG. 7 is a perspective view of the present invention mounted on a steering wheel; and,

FIG. 8 is a perspective view of the present invention in a folded configuration.

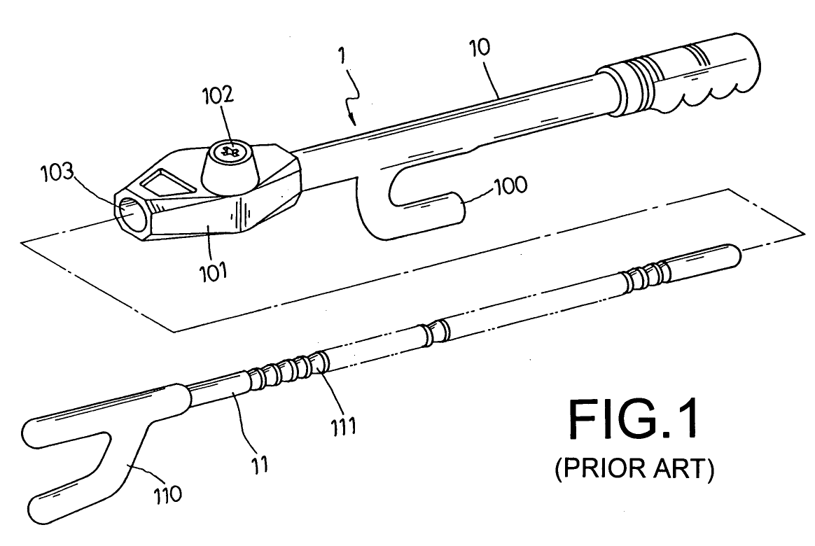

### DETAILED DESCRIPTION OF THE PREFERRED EMBODIMENTS

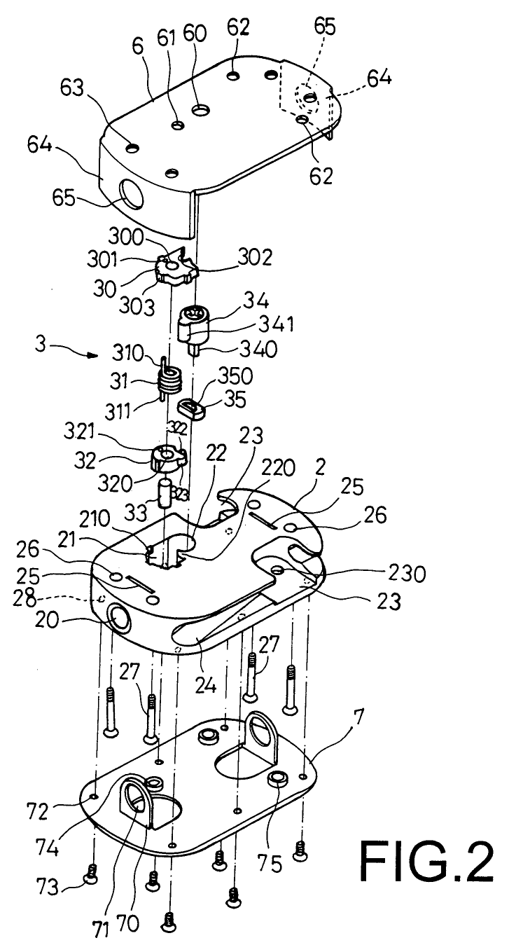

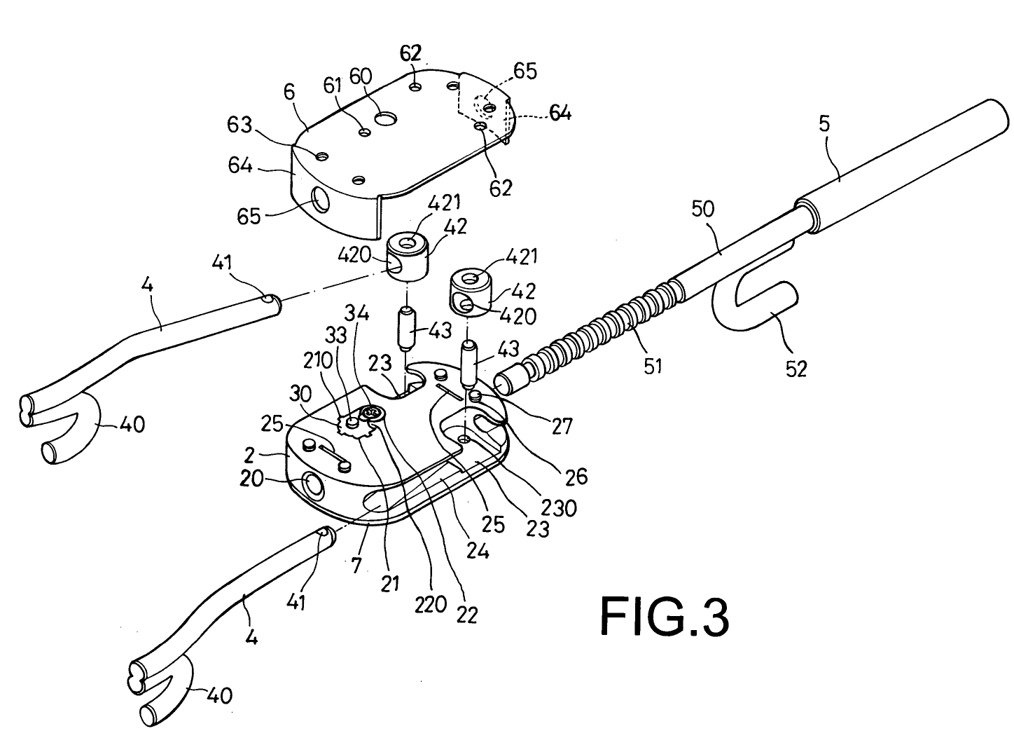

Referring to FIGS. 2 and 3, the present invention comprises a lock body 2 through which a channel 20 passes and within which a chamber 21 is formed. The chamber 21 connects with the channel 20 on one side at the bottom thereof. A plurality of retaining notches 210 is provided around the top opening of the chamber 21. A recess room 22 is formed within the lock body 2 aside the chamber 21, which directly connects with the chamber 21. A retaining flange 220 is introduced between the chamber 21 and the recess room 22. Two opposite lateral sides of the lock body 2 are each provided with an indentation 23 and a locating notch 24, which indentation 23 is further provided with a pivot hole 230. Furthermore, two slots 25 are formed on the top surface of the lock body 2, each connecting to the channel 20. Four through holes 26 for housing connecting pins 27 are formed in the lock body 2, going form the top surface to the bottom surface thereof. A plurality of screw holes 28 is formed on the bottom surface of the lock body 2.

The present invention further comprises a lockset 3 housed in the chamber 21 and in the recess room 22 of the lock body 2. The lockset 3 consists of a base 30, a spring coil 31, a stop block 32, a lock core 34 and a rotatable plate 35, wherein the base 30, the spring coil 31, the stop block 32 and the pivot 33 are located within the chamber 21. The base 30 is provided with a pivot hole 300 and an insertion hole 301. And the base 30 further includes an arced recess 302 formed on a lateral side thereof and a plurality of projections 303 formed around the rim thereof. The spring coil 31, located below the base 30, has one end inserted in the insertion hole 301 on the base 30 and the other end inserted on the stop block 32. The stop block 32, located below the spring coil 31, is provided with a pivot hole 320 and an insertion hole 321. A locking tooth 322 and a projection 323 are formed on the lateral wall of the stop block 32. The pivot 33 goes through the pivot hole 320 of the stop block 32, the axial channel of the spring coil 31 and the pivot hole 300 on the base 30. The lock core 34 and the rotatable plate 35 are housed within the recess room 22 of the lock body 2. The lock core 34 is provided with a shaft 340 ejected from the bottom thereof and a projection 341 on a lateral wall thereof. The rotatable plate 35 is engaged with the shaft 340 under the lock core 34, having an insertion slot 350 thereon.

The present invention further comprises a pair of hooked rods 4, mounted within the locating notches 24 of the lock body 2. Each of the hooked rods 4 is provided with a hook member 40 at a first end and a pivot hole 41 at a second end. A pivot stand 42 is mounted onto the second end of each of the hooked rods 4. The pivot stands 42 are respectively pivotally mounted into the indentations 23 of the lock body 2. Each of the pivot stands 42 is provided with an insertion hole 420 and a pivot hole 421, perpendicular to and intersecting each other within the pivot stands 42. A pivot 43 is inserted through each of the pivot holes 421.

The present invention further comprises a central rod 5 going through the channel 20 within the lock body 2. The rod body 50 of the central rod 5 is provided with a plurality of annular grooves 51 distributed along one end section thereof and a hook member 52 in another end section thereof.

The present invention further comprises an upper shell 6 that encloses the lock body 2, on which a keyhole 60 is provided. The upper shell 6 is further provided with pivot holes 61, 62 corresponding to the pivots 33, 43 in the lock body 2, four screw holes 63 on the top face thereof and two retaining walls 64 respectively extending downwardly from two lateral sides thereof. A through hole 65 is formed on each of the retaining walls 64.

The present invention further comprises a lower shell 7 that is attached on the bottom of the lock body 2. The lower shell 7 is provided with two retaining tongues 70 each having a through hole 71 and a plurality of screw holes 72 for inserting screws 73. The lower shell 7 is further provided with pivot stands 74, 75 corresponding to the pivots 33, 43 of the lock body 2.

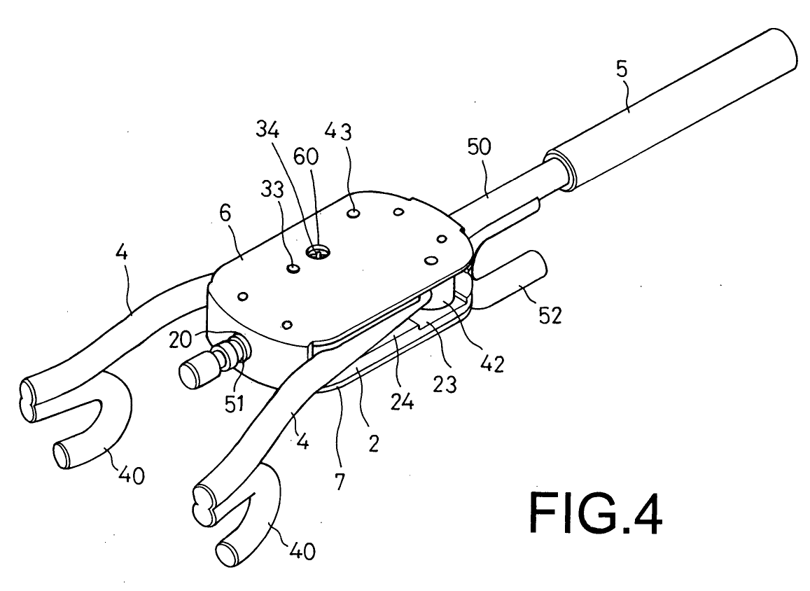

Referring to FIGS. 2, 3, 4 and 5 for assembling the automobile steering wheel lock. The pivot 33 is firstly inserted through the pivot hole 320 on the stop block 32, the spring coil 31 and the pivot hole 300 on the base 30. The spring coil 31 is then sandwiched between the base 30 and the stop block 32 by inserting one end tip thereof into the insertion hole 301 and the other end tip into the insertion hole 321. The combination of the stop block 32, the spring coil 31, the base 30 is then put into the chamber 21 of the lock body 2, with the locking tooth 322 extending into the recess room 22 of the lock body 2 and being retained by the retaining flange 220 between the chamber 21 and the recess room 22. The rotatable plate 35, being engaged with the shaft 340, is put into the recess room 22 of the lock body 2 together with the lock core 34. The projection 341 of the lock core 34 is embedded into the recess 302 of the base 30 for retaining the lock core 34 properly. The ends of the hooked rods 4 having a pivot hole 41 are respectively inserted into the insertion holes 420 of the pivot stands 42, each of which further houses a pivot 43 in a pivot hole 421 therein. The pivots 43 extend through the pivot holes 41 of the hooked rods 4. The pivot stands 42 are mounted within the indentations 23 of the lock body 2, and then the hooked rods 4 are respectively retained within the locating notches 24 of the lock body 2. The lock body 2 is enclosed by the upper shell 6, with the screw holes 63 on the upper shell 6 being aligned with the through holes 26 of the lock body 2. The connecting pins 27 are then inserted through the through holes 26 of the lock body 2 into the screw holes 63 on the upper shell 6 and screw-locked. The keyhole 60 on the upper shell 6 is now aligned with the lock core 34 of the lock body 2. The upper portion of the pivot 33 is now inserted in the pivot hole 61 on the upper shell 6, and the pivots 43 on the pivot stands 42 are respectively inserted in the pivot holes 62 on the upper shell 6. Furthermore, the through holes 65 on two retaining walls 64 of the upper shell 6 are aligned with the channel 20 of the lock body 2. The lower shell 7 is fixedly attached onto the bottom of the lock body 2 by tightening the screws 73 that go through the screw hole 72 and the screw holes 28 in the lock body 2, during which the retaining tongues 70 thereon are respectively inserted into the slots 25 of the lock body 2. The through holes 71 are aligned with the channel 20 in the lock body 2. The lower portion of the pivot 33 is now in the pivot stand 74 of the lower shell 7, and the lower portions of the pivots 43 are now respectively in the pivot stands 75 on the lower shell 7. Finally, the central rod 5 is inserted into the channel 20 of the lock body 2, with the projection 323 of the stop block 32 lodged in one of the annular grooves 51 thereon. This completes the assembly of the automobile steering wheel lock.

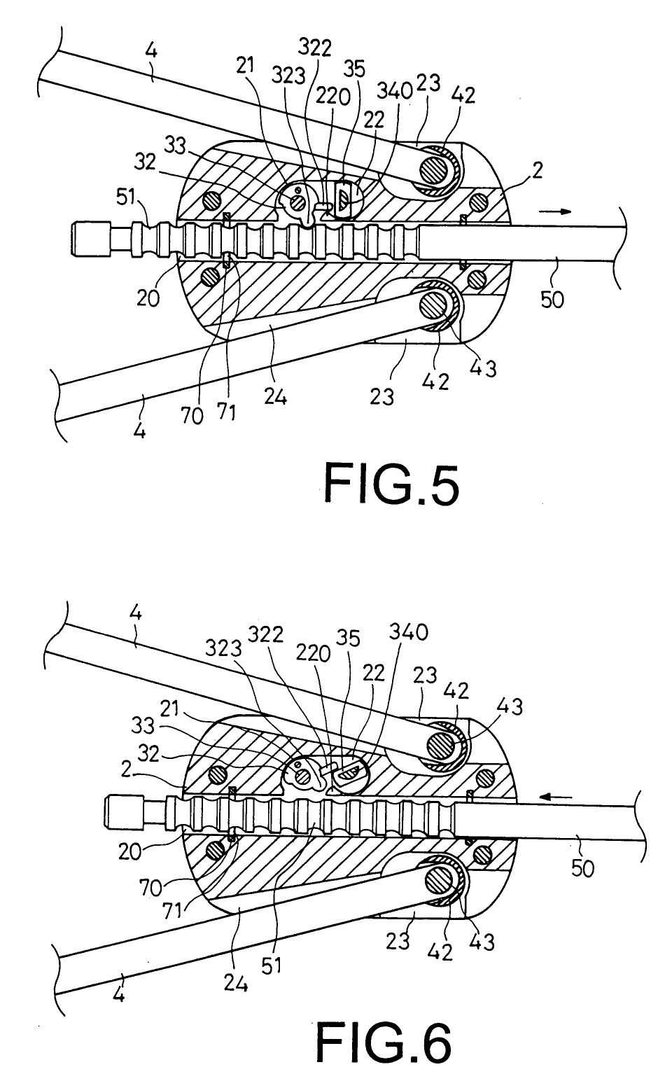

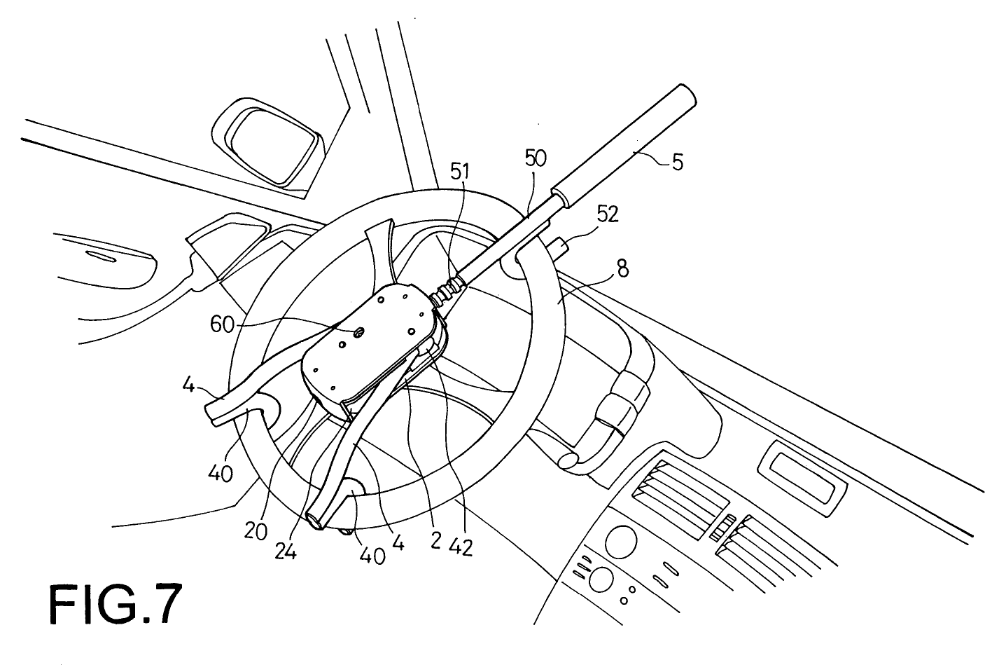

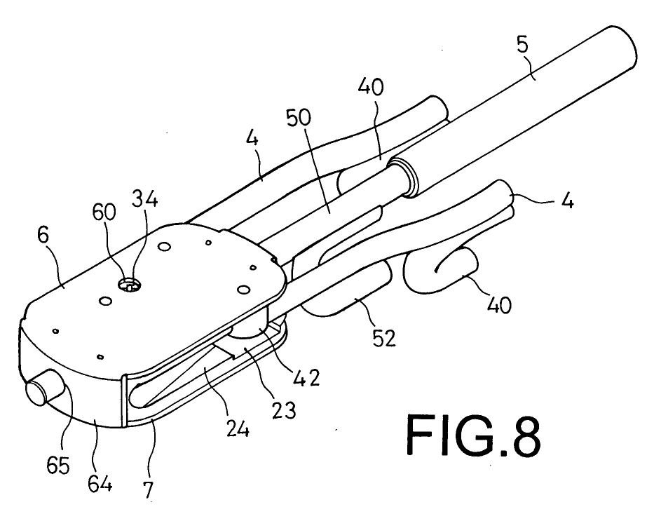

Please refer to FIGS. 5 and 7 for the usage of the automobile steering wheel lock. To lock the automobile steering wheel lock, the hook members 40 of the hooked rods 4 are engaged with the inner rim of the steering wheel 8. The central rod 5 is then pulled outwardly from the lock body 2 till the hook member 52 thereof is engaged with the opposite inner rim of the steering wheel 8, during which the projection 323 of the stop block 32 is continuously pushed aside by the annular-groove section of the central rod 5. As the projection 323 is pushed aside, the stop block 32 rotates accordingly and the spring coil 31 thereon is torsionally deformed. Therefore, when another annular groove 51 moves by the locking tooth 322, the projection 323 is pushed back into the annular groove 51 by the restoring torque of the spring coil 31. Because of the engagement of the locking tooth 322 of the stop block 32 with the retaining flange 220, the central rod 5 can move outwardly from the lock body 2 and cannot move the other way. Attached by the automobile steering wheel lock, not only the steering wheel 8 cannot be turned, but also the lock body 2 blocks the airbag thereof to prevent it from being taken away.

To unlock the automobile steering wheel lock, a key is inserted into the lock body 2 to rotate the lock core 34 therein, and the shaft 340 of the lock core 34 turns the rotatable plate 35 to rotate the locking tooth 322 of the stop block 32. As the stop block 32 rotates accordingly, the spring coil 31 is turned into a stressed configuration and the projection 323 of the stop block 32 departs from the annular groove 51, making the central rod 5 capable of being retracted toward the lock body 2. The hook member 52 of the central rod 5 thereby moves away from the inner rim of the steering wheel 8, allowing the release of the hooked rods 4 from the steering wheel 8. The hooked rods 4 are then rotated backwardly about the pivots 43 till the hook members thereon are aligned in the same direction with the hook member on the central rod 5. The automobile steering wheel lock thus folded becomes compact in size and easy for storage.

Accordingly to the above description, the automobile steering wheel lock is advantageous in:

1. being easily operable;

2. providing a better anti-theft effect by preventing a steering wheel from turning;

3. preventing the airbag from being taken away by attaching the lock body onto the airbag receptacle; and,

4. being capable of shrinking its size for storage.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. An automobile steering wheel lock comprising:
a key body through which a channel passes having a chamber and a recess room connectedly formed therein, the chamber connecting with the channel on a lateral side thereof, two opposite lateral sides of the lock body being each provided with an indentation and a locating notch;
a lockset housed within the chamber and the recess room;
two hooked rods mounted within the locating notches of the lock body, each of the hooked rods being provided with a hook member at a first end thereof and a pivot stand at a second end thereof, each of the pivot stands being pivotally mounted onto a bottom inner wall of a corresponding indentation; and,
a central rod housed within the lock body through the channel therein, a rod body of the central rod being provided with a plurality of annular grooves that distribute along a first end section thereof, a hook member being fixedly mounted a second end section of the rod body.

2. The automobile steering wheel lock of claim 1, wherein a retaining flange is introduced between the chamber and the recess room; around a top opening of the chamber there are a plurality of retaining notches formed; each of the indentations is provided with a pivot hole; two slots are formed on a top surface of the lock body, each connecting with the channel.

3. The automobile steering wheel lock of claim 1, wherein the lockset consists of a base, a spring coil, a stop block, a lock core and a rotatable plate; the base, the spring coil, the stop block and the pivot are housed within the chamber; the lock core and the rotatable plate are housed within the recess room.

4. The automobile steering wheel lock of claim 3, wherein the base is provided with a pivot hole and an insertion hole; the base includes an arced recess formed on a lateral side thereof and a plurality of projections formed around the rim thereof; the spring coil, being located below the base, has a first end tip inserted in the insertion hole on the base and a second end tip inserted on the stop block; the stop block, being located below the spring coil, is provided with a pivot hole and an insertion hole; a locking tooth and a projection are formed on a lateral wall of the stop block; the pivot goes through the pivot hole of the stop block, the spring coil and the pivot hole on the base; the lock core is provided with a shaft ejected from the bottom thereof and a projection on a lateral wall thereof; the rotatable plate is engaged with the shaft and has an insertion slot formed thereon.

5. The automobile steering wheel lock of claim 1, wherein each of the hooked rods is provided with a pivot stand at a second end thereof; each of the pivot stands is provided with an insertion hole and a pivot hole that intersect each other within a pivot stand; a pivot is inserted through each of the pivot holes.

6. The automobile steering wheel lock of claim 1, wherein an upper shell is mounted on the lock body; the upper shell is provided with a keyhole thereon and a plurality of pivot holes therein; the upper shell further includes two retaining walls respectively extending downwardly from two lateral sides thereof, each of the retaining walls having a through hole.

7. The automobile steering wheel lock of claim 1, wherein a lower shell, attached on a bottom surface of the lock body, is provided with a plurality of retaining tongues, each having a through hole, and a plurality of pivot stands.
